(19) United States
(12) Patent Application Publication
(10) Pub. No.: US 2013/0133404 A1
(43) Pub. Date: May 30, 2013

(54) APPARATUS AND METHOD FOR DETECTING MOLD GROWTH CONDITIONS

(71) Applicants: Diptesh R. Patel, Aurora, IL (US); Jeffrey D. Koon, Lombard, IL (US); Ronni L. Emrich, Norridge, IL (US)

(72) Inventors: Diptesh R. Patel, Aurora, IL (US); Jeffrey D. Koon, Lombard, IL (US); Ronni L. Emrich, Norridge, IL (US)

(73) Assignee: TAYLOR PRECISION PRODUCTS, INC., Oak Brook, IL (US)

(21) Appl. No.: 13/304,985

(22) Filed: Nov. 28, 2011

(51) Int. Cl. G01N 19/10

(52) U.S. Cl. 73/29.02

(57) ABSTRACT

A system for detecting a mold condition has a base unit configured to receive and display the temperature and the humidity from a remote sensing unit. The base unit is configured to determine if a mold condition is present at a location of the remote sensing unit based on a time interval the remote sensing unit detects the humidity and the temperature above predetermined thresholds, and display an indicator if the mold condition is present. A method of detecting a mold condition includes wirelessly transmitting a detected humidity and temperature from a sensing unit to a base unit, monitoring the temperature and the humidity across a time interval, and providing an indicator if the mold condition is present when the temperature and the humidity are above predetermined thresholds for the time interval.

### TECHNICAL FIELD

Various embodiments relate to an apparatus and a method for detecting conditions for mold growth and providing an alert.

### BACKGROUND

Mold growth may depend on humidity, temperature, and time. There are various household molds which grow in different temperature and humidity ranges.

### BRIEF DESCRIPTION OF THE DRAWINGS

FIG. 1 is a diagram of a mold condition detection system having multiple remote sensing units according to an embodiment;

FIG. 2 is a schematic of a base unit of the mold condition detection system of FIG. 1;

FIG. 3 is a schematic of a remote sensing unit of the mold condition detection system of FIG. 1; and

FIG. 4 is a flow chart of a mold condition sensing algorithm for use with the mold condition detection system of FIG. 1.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

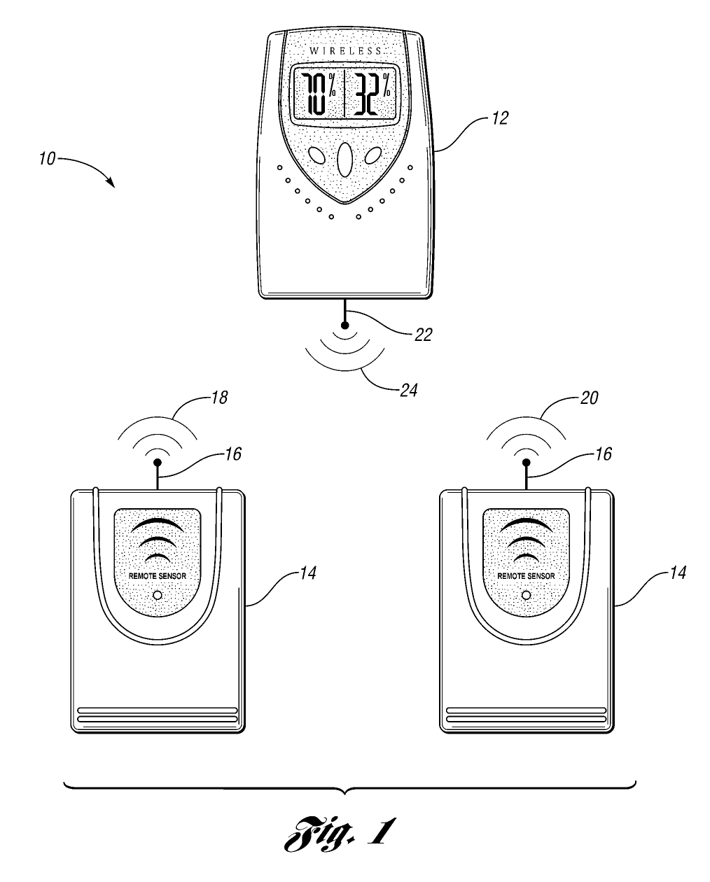

The mold condition detector system 10, including a base unit 12 and one or more remote sensors 14 as shown in FIG. 1, informs the user of the possibility of mold growth at a location of the remote sensor 14 by detecting conditions that facilitate mold growth and alerting the user when the conditions exist for a predetermined length of time. In particular, the system 10 monitors temperature, humidity, and time at a particular location to determine if a condition for mold growth is present.

In one embodiment, a mold condition occurs when the humidity is greater than sixty percent and the temperature is higher than seventy degrees Fahrenheit for more than two hours at the remote sensor 14. In other embodiments, the humidity threshold may be within the range of fifty-five to sixty-five percent, or fifty to seventy percent, or may be another percentage humidity as is known in the art. The temperature threshold may be within the range of sixty-five to seventy-five degrees Fahrenheit, or sixty to eighty degrees Fahrenheit, or be another temperature as is known in the art. The predetermined time period may be within a range of one and a half hours to two and a half hours, or one to three hours, or be another time as is known in the art. Of course, various humidity, temperature, and time limits and combinations thereof are envisioned for use with the detector system 10. When a mold condition is present, the base unit 12 and the remote sensing unit 14 provide an indication or alert to advise the user that conditions facilitate mold growth. At this point, the user may take action to prevent mold from growing at the location by using a dehumidifier, fans, opening a window, changing the temperature, or the like.

The mold condition detector system 10 informs the user of the possibility of mold growth by alerting the user when atmospheric conditions are contributing to mold growth. There are various house and indoor molds which grow in different temperature and humidity ranges. Three contributing factors to mold growth are temperature (T), humidity (or relative humidity, (φ), and time (t). The system 10 alerts the user when conditions exist which permit or promote the growth of mold.

As described above with reference to FIG. 1, the system 10 has a base unit 12 and at least one remote sensing unit 14. The remote sensing unit 14 is placed in a location to monitor for potential mold growth. The remote sensing unit 14 may be placed in a basement, bathroom, attic, difficult access area, or any other location within a building as selected by the user. The remote sensing unit 14 wirelessly communicates with the base unit 12, which provides an interface with the user and alerts the user. The base unit 12 may be placed in a central or easily accessible area of the building for ease of monitoring and use by the user. Multiple remote sensing units 14 may be used with the base unit 12 such that a user may monitor multiple locations for the potential for mold from a single, easily accessible location of the base unit 12. Alternatively, a single remote sensing unit 14 may be used with the base unit 12.

The remote sensing units 14 communicate wirelessly with the base unit 12 using a wireless signal. Different remote sensing units 14 may communicate over different wireless channels to prevent interference when communicating with the base unit 12. The remote sensing units 14 have a wireless antenna 16, which is configured to send and receive a wireless signal. For example, with a system 10 including two remote sensing units 14, there is a wireless signal 18 over a first channel and a wireless signal 20 over a second channel. The remote sensing units 14 may be configured such that a user selects the channel, or alternatively the base unit 12 may assign channels to various remote sensing units 14 after scanning the network and identifying the remote sensing units 14 within the system 10.

The base unit 12 has a wireless antenna 22 which is configured to send and receive a wireless signal 24 across one or more channels to communicate with the remote sensing units 14.

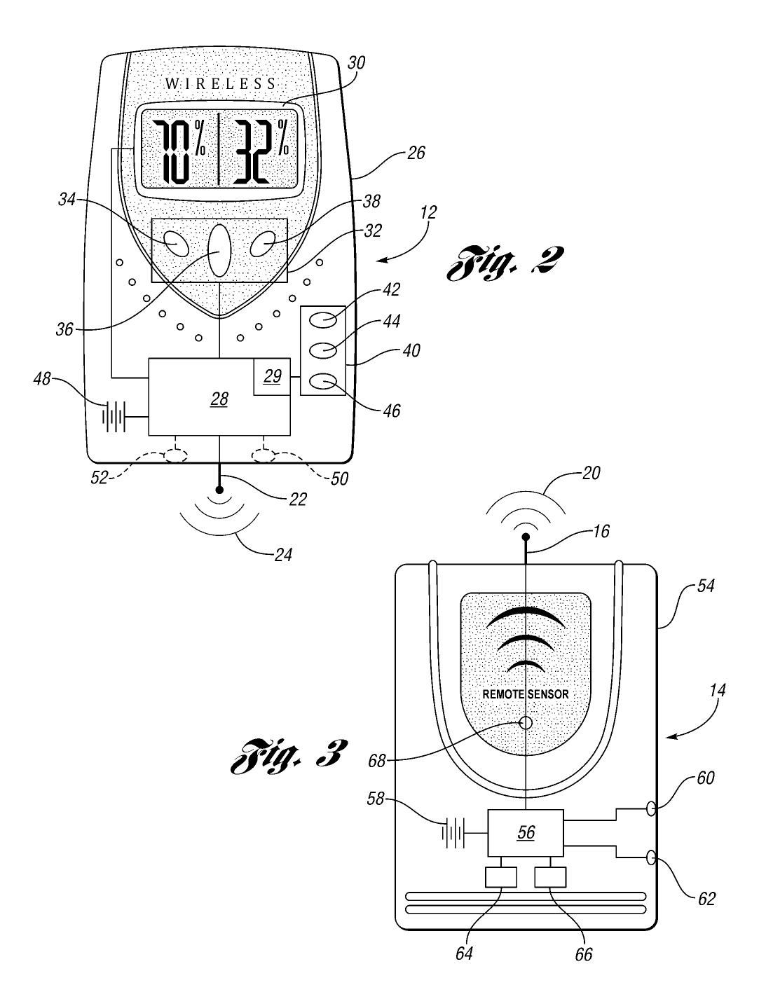

The base unit 12 is shown in detail in FIG. 2. The base unit 12 has a housing 26 which is adapted to be mounted on a wall, or may be positioned on a table, or the like. A controller 28 is disposed within the housing 26. The controller 28 is in communication with the wireless antenna 22 and receives the wireless signal 24 from the antenna 22. The controller 28 is also in communication with a display 30. The display 30 is supported by the housing and may be a liquid crystal display (LCD), or other display as is known in the art.

In one embodiment, the display 30 may show the temperature and the humidity from one of the remote sensing units 14. The display 30 may also show which channel the base unit 12 is communicating on, which corresponds to which remote sensing unit 14 the temperature and humidity data is coming from. For example, there may be one, two, three, or any other number of channels for use with a corresponding number of remote sensing units 14. The display 30 may also display an indication or alert indicating the presence of a mold condition, or if the alert has been turned on. If a mold condition is present and the alert is on, the display 30 may show or flash “MOLD” or another word or symbol, and may also have an audible alert such as a buzzer or chime through a speaker in the base unit 12. If the mold condition alert has occurred, the display may show “A O” or another word or symbol representing that the alert is on. In some embodiments, the base unit 12 may turn the mold condition alert off if the conditions have changed such that a mold condition no longer exists.

The base unit 12 has a user interface 32, which may be located on the front face of the housing 26. The user interface 32 provides multiple inputs from the user to the unit 12 and is in communication with the controller 28. For example, as shown in FIG. 2, the user interface 32 includes tactile buttons, or alternatively, may include a touch screen or the like. A minimum/maximum (MIN/MAX) button 34 may be provided such that display screen 30 displays the minimum and/or maximum temperature and humidity from the selected remote sensing unit 14.

An alert (ALERT/RESET) button 36 turns the alert on or off for a particular remote sensing unit 14. In some embodiments, the alert 36 will not reset, or turn off, the visual alert on the display 30 until the temperature falls below a threshold value and/or the humidity falls below a threshold value.

A scroll (SCROLL) button 38 may be provided to allow the user to select the channel for the unit 12 to show information from that respective remote sensing unit 14 on the display 30. The display 30 may indicate to the user if there is an alert from one of the remote sensing units 14 by having an alert show with that channel as the user scrolls through the multiple channels on the display 30 using the scroll button 38.

A second user interface 40 is also provided on the unit 12, and may be located on the back of the housing 26, the side of the housing 26, or under a cover or door of the housing 26. Alternatively, the second user interface 40 may be combined with the user interface 32, such as on the front face of the housing 26. The second user interface 40 provides multiple inputs from the user to the unit 12 and is in communication with the controller 28. The second user interface 40 includes tactile buttons, or alternatively, may include a touch screen or the like. A button 42 or switch allows the user to select Celsius or Fahrenheit as the temperature scale for use on the display 30.

An alert button 44 allows the user to turn an audible indicator alarm on or off if the base unit 12 is equipped with an audible alarm. In some embodiments, the alert button 44 may also be used to turn off the visual alert, but may be limited to when the temperature and/or humidity have fallen below the respective threshold values for a mold condition alert.

A clear button 46 allows the user to clear the maximum and minimum temperature and humidity values from the controller 28 memory and from the display 30. The clear button 46 may clear the data from a specific channel, or alternatively may clear the data from the base unit 12 for all channels.

The base unit 12 may be powered by a direct current source such a replaceable or rechargeable battery 48, or alternatively, may be wired into an alternating current source, such as 110 volt wiring in a building.

In some embodiments, the base unit 12 may have a temperature sensor 50 and humidity sensor 52. This permits the base unit 12 to act as an additional mold condition sensor for the location that the unit is placed. If the base unit 12 has a temperature and humidity sensor 50, 52, the display 30 and the scroll button 38 would indicate the base unit 12 as being an additional data source, similar to the various selectable channels.

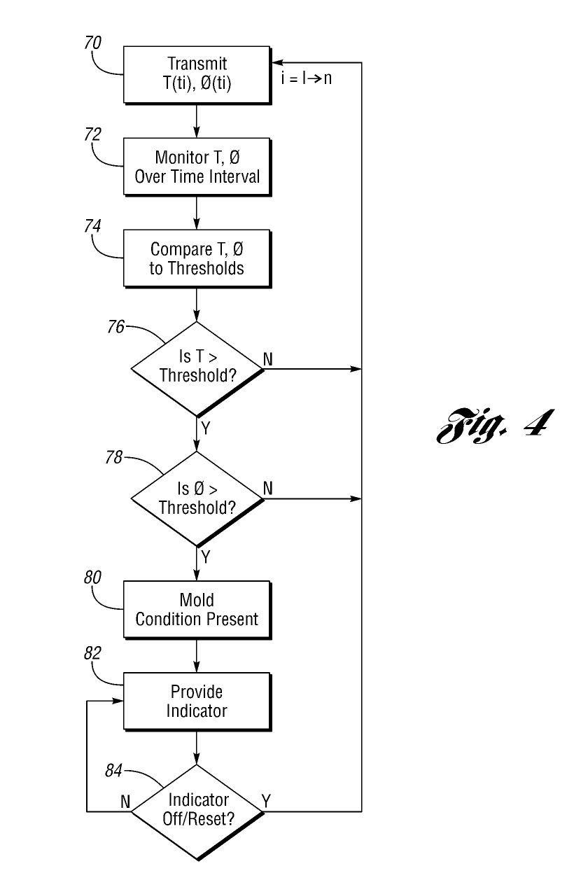

A remote sensing unit 14 is shown in FIG. 3. The remote sensing unit 14 has a housing 54, which may be configured such that the remote sensing unit 14 may be mounted to a wall or other structure. Alternatively, the remote sensing unit 14 may be placed on a surface. The remote sensing unit 14 is placed by the user in a location where the user wishes to determine if the conditions allow mold and mold growth. For example, the remote sensing unit 14 may be placed in a basement, an attic, a bathroom, or other location as chosen by the user.

A controller 56 is disposed within the housing 54. The controller 56 is connected to a power source 58. The power source 58 may be a battery, such as a replaceable or rechargeable battery, or alternatively, may be a connection to an alternating current source, such as a 110 Volt wall outlet, or the like.

The housing 54 supports a temperature sensor 60 in communication with the controller 56. The temperature sensor 60 may be a thermistor, resistance temperature detector, thermocouple, or other temperature measuring sensor as is known in the art. The temperature sensor 60 provides an electrical signal to the controller 56, which is calibrated to interpret the signal and determine the ambient temperature in the remote sensing unit 14 location. In alternative embodiments, the remote sensing unit 14 sends the raw signal to the base unit 12 for the base unit 12 to determine the temperature. The temperature may be determined either in degrees Celsius or degrees Fahrenheit.

The housing 54 supports a humidity sensor 62 in communication with the controller 56. The humidity sensor may be a hygrometer, humidistat, capacitive, resistive or thermal conductivity humidity sensor, or other humidity measuring sensor as is known in the art. The humidity sensor 62 provides an electrical signal to the controller 56, which is calibrated to interpret the signal and determine the humidity in the remote sensing unit 14 location. In alternative embodiments, the remote sensing unit 14 sends the raw signal to the base unit 12, for the base unit to determine the humidity.

The signal measured by the humidity sensor 62 may be used to determine the relative humidity of the ambient air at the remote sensing unit 14 location. The relative humidity, φ, is the ratio of the partial pressure of water vapor (in a gaseous mixture of air and water vapor) to the saturated vapor pressure of water at a given temperature, and is expressed as a percentage. Relative humidity is typically used in climate control situations. In other embodiments, the humidity sensor 62 may measure the absolute humidity, or amount of water content in the air, and then the controller 56 may determine the relative humidity.

The controller 56 receives the signals from the temperature sensor 60 and the humidity sensor 62 and provides, for example, a temperature and relative humidity for the ambient air at a specified time. The data may be time stamped by the controller 56, and then sent to the base unit 12. Alternatively, the base unit 12 may provide a time stamp for the data when it is received by the unit 12.

The temperature and humidity data is wirelessly transferred using a signal 20 provided by the wireless antenna 16 of the remote sensing unit 14. The base unit 12 receives the signal 20. The remote sensing unit 14 may wirelessly transmit the data over one of several channels, such as channel 1, 2, and 3. A switch 64 is in communication with the controller 56 such that a user may select which channel the remote sensing unit 14 is transmitting on. The switch 64 may be a sliding switch, or other switch mechanism as is known in the art. The switch 64 may be located on an outer surface of the housing 54, or alternatively, may be located inside a battery 58 compartment, or under an access door.

A transmit (TX) button 66 is also supported by the housing 54 and connected to the controller 56. The transmit button 66 forces the remote sensing unit 14 to send a signal at that time. The transmit button 66 may be located on an outer surface of the housing 54, or alternatively, may be located inside a battery 58 compartment, or under an access door. Otherwise, the remote sensing unit 14 may send a signal either at specified time intervals, such as every two and a half minutes, or whenever there is a significant change in the temperature or the humidity at the location of the remote sensing unit 14.

The antenna 20 on the remote sensing unit 14 and the antenna 22 on the base unit 12 may have a transmitting range. Based on the power to the antennae 20, 22, the units 12, 14 may need to be within a specified distance of one another in order to communicate. For example, the remote sensing unit 14 may need to be within 100 feet of the base unit 12. Of course, other distances are also contemplated for use with the units 12, 14.

The units 12, 14 wirelessly communicate over a predetermined band of spectrum. Each of the remote sensing units 14 transmit over a separate channel within the predetermined band to prevent interference with one another. The units 12, 14 may operate using 433 MHz frequency bandwidth, which provides for low power communication. The 433 MHz band refers to an ultra-high frequency band from 433.075 MHz to 434.775 MHz with 25 kHz channel spacing. The wireless transmissions propagate through walls and other obstructions. Of course, other spectrum and channel spacing is also contemplated for use with the units 12, 14.

The remote sensing unit 14 has a visual alert 68 located on an outer surface of the housing 54 and in communication with the controller 56. The visual alert 68 may be a light emitting diode or other light source. The visual alert 68 is activated by the controller 56, for example, when a mold condition is present or to indicate that a successful transmission was sent.

A basic flowchart showing the process for determining a mold alert condition is shown in FIG. 4. The values used in the example are for illustration only, and other values are contemplated for use with detector system 10. FIG. 4 illustrates the interaction between the base unit 12 and one of the remote sensing units 14 across a single channel. The base unit 12 may also be communicating with other remote sensing units 14 to check for mold conditions at other locations simultaneously.

A temperature and humidity are sensed and transmitted from the remote sensing unit 14 to the base unit 12 at step 70. The remote sensing unit 14 continues to measure and transmit temperature and humidity data at specified time intervals, such as every minute. The base unit 12 receives and monitors the temperature and humidity measurements and stores the temperature and humidity data with respective time stamps over a time interval at step 72 in a memory 29 of the controller 28. The base unit 12 may store a history of the temperature and humidity data for an interval, such as the past two hours for example, in the memory 29.

The base unit 12 compares the temperature and humidity data to predetermined thresholds for a mold condition at 74 across the time interval. For example, the temperature is compared to the temperature threshold, which may be seventy degrees Fahrenheit, as shown at 76. The humidity is compared to the humidity threshold, which may be sixty percent relative humidity, as shown at 78. Alternatively, the humidity comparison 78 may occur before the temperature comparison 74. Of course, other threshold values for the temperature and humidity are also contemplated for use with the system 10.

The base unit 12 may compare every temperature and humidity measurement for the time interval to the thresholds at 76, 78, or alternatively, may have an algorithm to compare the temperature and humidity data to the thresholds. For example, the mold condition may occur when the each humidity measurement is greater than sixty percent and each temperature measurement is higher than seventy degrees Fahrenheit across a time interval of two hours.

In other embodiments, the temperature and humidity data may be averaged over the time interval and the average values compared to the thresholds. The algorithm may be able to recognize an outlier, such as a missed data point during the time interval, or if a percentage of the temperature and humidity measurements are above the thresholds for the time interval.

If both the temperature and humidity are above their respective thresholds for the time interval, a mold condition is present at the location of the remote sensing unit 14 and is flagged at 80.

Once a mold condition is flagged at 80, the base unit 12 provides an alert at 82. The base unit 12 turns on its visual and audio alert indicators. The base unit 12 displays a visual alert on the display 30 for the channel that the remote sensing unit 14 is transmitting on, and additionally may provide an audible chime or buzzer. For example, the audio alert indicator may provide a chime every three seconds per minute. The base unit 12 also sends a signal to the remote sensing unit 14 to activate the visual indicator 68 on the remote sensing unit 14.

The visual and audio indicators remain on until the user turns off the indicator or resets the base unit 12 as shown at 84.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A mold condition detection system comprising:
a remote sensing unit configured to detect a temperature and a humidity and wirelessly transmit the temperature and the humidity; and
a base unit configured to receive the temperature and the humidity from the remote sensing unit, the base unit configured to determine if a mold condition is present at a location of the remote sensing unit based on a time interval over which the remote sensing unit detects the humidity and the temperature above predetermined thresholds;
wherein the base unit is configured to produce an alert if the mold condition is present.

2. The detection system of claim 1, wherein the mold condition is present if the temperature is at least seventy degrees Fahrenheit and the humidity is at least sixty percent for a time interval of at least two hours.

3. The detection system of claim 1, wherein both the base unit and the remote sensing unit are configured to produce an indicator if the mold condition is present.

4. The detection system of claim 1, wherein the indicator is produced until the mold condition is no longer present.

5. The detection system of claim 1, wherein the indicator is produced until the indicator is manually turned off.

6. The detection system of claim 1 wherein the base unit includes a display screen which is configured to display the temperature and the humidity from the remote sensing unit.

7. The detection system of claim 1, wherein the base unit is configured to display maximum and minimum values of temperature and humidity during the time interval.

8. The detection system of claim 1 further comprising a second remote sensing unit configured to detect a temperature and a humidity and wirelessly transmit the temperature and the humidity;
wherein the base unit is configured to receive the temperature and the humidity from the second remote sensing unit.

9. The detection system of claim 8 wherein the base unit is configured to connect to the remote sensing unit on a first channel, and the second remote sensing unit on a second channel; and

[symbol]

10. The detection system of claim 9 wherein the base unit has an interface to select to display information from one of the first channel and the second channel.

11. The detection system of claim 1 wherein the alert is an audible alert.

12. The detection system of claim 1 wherein the alert is a visual alert.

13. A method of detecting a mold condition, the method comprising:
detecting a humidity and a temperature using a sensing unit positioned at a first location to determine if a mold condition is present at the first location;
wirelessly transmitting the humidity and the temperature from the sensing unit to a base unit positioned at a second location;
monitoring the temperature and the humidity across a time interval;
providing an alert that the mold condition is present at the first location when the temperature and the humidity are above predetermined thresholds for the time interval.

14. The method of claim 13 wherein the alert is an audible alert produced from one of the base unit and the sensing unit when the mold condition is present.

15. The method of claim 13 wherein the alert is a visual alert on the base unit when the mold condition is present.

16. The method of claim 13 further comprising displaying the temperature and the humidity on a display of the base unit.

17. The method of claim 13, wherein the mold condition is present if the temperature is at least seventy degrees Fahrenheit and the humidity is at least sixty percent for at least two hours.

18. The method of claim 13, wherein the alert is provided until the mold condition is no longer present.

19. The method of claim 13 wherein the alert is provided until the alert is manually turned off.

20. A system for detecting a condition for mold, the system comprising:
a sensing unit having a temperature sensor and a humidity sensor, the sensing unit configured to wirelessly transmit a temperature and a humidity; and
a base unit configured to receive the transmitted temperature and the transmitted humidity, the base unit monitoring the temperature and the humidity across a time interval, the base unit configured to provide an alert when the temperature and the humidity are above predetermined thresholds for the time interval.
